(19) United States
(12) Patent Application Publication
(10) Pub. No.: US 2026/0001988 A1
(43) Pub. Date: Jan. 1, 2026

(54) Integrated System and Process for Producing Polyamides from Circular Components

(71) Applicant: Celanese Polymers Holding, Inc., Wilmington, DE (US)

(72) Inventors: Michael Chisholm, Newark, DE (US); Jacob Dickinson, Detroit, MI (US); Shailesh Doshi, Kingston (CA); Stephan Eilbracht, Geneva (CH)

(21) Appl. No.: 19/249,007

(22) Filed: Jun. 25, 2025

Related U.S. Application Data
(60) Provisional application No. 63/664,516, filed on Jun. 26, 2024.

(51) Int. Cl. C08G 69/26; C08G 69/28; C08J 5/04; C08K 7/14; H01R 43/18

(52) U.S. Cl. CPC C08G 69/265; C08G 69/28; C08J 5/043; C08K 7/14; C08J 2377/06; H01R 43/18

(57) ABSTRACT

A process is disclosed for producing polyamide 66 polymers from at least one circular atom component. The circular atom component, for instance, can comprise a fluid obtained from biomass or from an industrial waste stream, such as an industrial gas stream that would otherwise be released to the environment. Polyamide 66 polymers are produced not only containing large amounts of circular atoms but also with excellent mechanical and physical properties.

### BACKGROUND

Nylon is a synthetic polymer and is a special type of polyamide polymer. Nylon is known for its toughness, strength, and elasticity. Nylon has a high melting point, good abrasion resistance, and excellent chemical resistance. These properties make nylon suitable for a wide range of applications.

Two types of widely used nylons include nylon 6 and nylon 66. Nylon 6 is made from a single monomer unit called caprolactam. Nylon 66, on the other hand, is made from two different monomer units. The two different monomer units include a diamine such as hexamethylene diamine and adipic acid.

Nylon 66 can be used alone or in combination with nylon 6. Nylon 66, for instance, is typically used in the textile industry to produce fibers. The nylon 66 fibers can be used to make fabrics, carpets, and apparel.

Nylon 66 is also used in engineering plastics due to its high tensile strength, stiffness and resistance to heat and chemicals. Nylon 66, for instance, can be used to produce automotive parts, electrical connectors, and industrial machinery.

Nylon 66 is also found in a wide range of consumer goods, including toothbrush bristles, kitchen utensils, and furniture components. Nylon 66 is also used to produce packaging materials, such as films and pouches, due to its toughness and barrier properties. Due to its chemical resistance, nylon 66 is also used in industrial applications, such as bearings, gears, rollers, and washers.

Nylons, particularly nylon 66, have conventionally been made from fossil-based components. Currently, however, there is a drive to move away from fossil-based materials. In particular, companies are actively seeking ways to reduce usage of fossil feedstocks and lower their carbon emissions.

In view of the above, a need currently exists for a process capable of producing bio-based components for producing nylon polymers, particularly nylon 66 polymers. A need also exists for a nylon 66 polymer that intrinsically has a circular (e.g. renewable or recaptured) atom content.

### SUMMARY

In general, the present disclosure is directed to industrial processes for producing polyamides, particularly polyamide 66 polymers. The polyamide 66 polymers are made from circular adipic acid and/or a circular diamine. One or both of the monomers can be produced from a renewable feedstock, such as a renewable natural gas source, in order to incorporate renewable or circular atoms, such as carbon atoms into the polymer structures.

In one aspect, for instance, the present disclosure is directed to a method for producing polyamide 66. The method includes forming a polyamide 66 polymer from a first monomer and a second monomer. At least a portion of the first monomer is formed from a circular feedstock component, such as a circular carbon feedstock, e.g. circular natural gas. As used herein, a circular feedstock refers to a component containing renewable atoms (e.g. derived from sources that can be replenished within a relatively short timeframe, such as less than about 100 years) or from recaptured atoms (e.g. atoms normally discarded or released to the atmosphere). The feedstock can be a circular carbon feedstock. Many circular feedstocks can be naturally regenerated or grown through sustainable practices. Circular feedstocks can be obtained from biomass, from bio-based products, from recycled materials or from atom capture processes, such as capturing carbon emissions from industrial processes. In accordance with the present disclosure, the circular feedstock is used directly, is used to produce other components that thereby contain circular atoms or is used as an energy source during the various process steps. The first monomer can comprise a diamine. The second monomer can comprise adipic acid. The circular feedstock, in one aspect, can comprise a circular or renewable natural gas.

In accordance with the present disclosure, the resulting polyamide 66 polymer has a circular atom content of at least about 10% by weight, such as at least about 14% by weight, such as at least about 18% by weight, such as at least about 20% by weight, such as at least about 25% by weight, such as at least about 30% by weight, such as at least about 35% by weight, such as at least about 41% by weight. The circular atom content can be determined according to a suitable circular atom certification process. Circular atom content, in one aspect, can be determined according to the International Sustainability & Carbon Certification (ISCC) rules, ISCC-PLUS v3.4.2 which is incorporated herein by reference. The ISCC certification process is a globally recognized certification system for sustainability, which certifies the chain of custody to track the sustainability characteristics along the supply chain. It covers various sectors, including agriculture, forestry, bioenergy, chemical, and polymer processes. The ISCC certification rules ensure that materials and products are sustainably sourced and processed, reducing environmental impact and promoting social responsibility. The ISCC certification ensures a mass balance approach is properly adopted, which can be used to trace the sustainability of raw materials along the entire supply chain. This involves tracking the amount of certified and non-certified material and ensuring that claims about sustainability can be verified. For example, the method allows for the calculation of the proportion of certified renewable (or circular) content in a mixed batch of materials. During the calculation, carbon and non-carbon atoms can be tracked and incorporated into the calculation. More information regarding the ISCC mass balance approach can be accessed from ISCC: e.g. ISCC EU System Document 202, 2024, https://www.iscc-system.org/process/certification-process/system-documents/, which is incorporated herein by reference.

In one aspect, the circular or renewable natural gas comprises a bio-based methane containing methane in an amount greater than about 80% by weight, such as in an amount greater than about 85% by weight, such as in an amount greater than about 90% by weight, such as in an amount greater than about 95% by weight.

The first monomer comprising the diamine can comprise hexamethylene diamine, 2-methylpentane-1,5-diamine, or mixtures thereof.

In forming the first monomer, the renewable natural gas can be steam reformed to produce hydrogen which is combined with nitrogen gas to form ammonia. The ammonia can be combined with additional amounts of the renewable natural gas to form hydrogen cyanide. The hydrogen cyanide can be used to form adiponitrile, which can be hydrogenated to form the first monomer. The ammonia as described above can be produced according to an endothermic reaction or an exothermic reaction. The adiponitrile can be formed by hydrocyanation of 1,3 butadiene. In one aspect, the 1,3 butadiene can also be formed from a circular carbon component comprising a circular pyrolysis oil, a circular cooking oil, a circular diesel, or a circular naphtha.

In an alternative embodiment, the renewable natural gas can be steam reformed to produce hydrogen which is combined with nitrogen gas to form ammonia. The ammonia is then combined with oxygen and propylene to form adiponitrile. The adiponitrile can be hydrogenated to form the first monomer. In this embodiment, the propylene can be formed from a circular carbon component such as the renewable natural gas or a circular pyrolysis oil or a circular naphtha, or a circular diesel or another type of circular oil.

In one aspect, the ammonia used in the process comprises blue ammonia, green ammonia, and/or turquois ammonia.

Polyamide 66 polymers made according to the present disclosure can have an excellent blend of physical properties and characteristics. The polyamide 66 polymer can have a relative viscosity of from about 2.3 to about 3.2 when tested according to ASTM Test D789 and/or D4878. The polyamide 66 polymer can be compounded with various other components to produce molded products. For instance, in one embodiment, the polyamide 66 polymer can be combined with glass fibers. The glass fibers can be present in the polymer composition in an amount from about 5% by weight to about 65% by weight. The polymer composition can also contain a lubricant or mold release agent, an antioxidant, a UV stabilizer, and the like. The present disclosure is also directed to molded articles made from the polyamide 66 polymer. In one aspect, the molded article comprises an electrical connector.

In another aspect, the present disclosure is directed to a method for producing a polyamide 66 polymer that includes the step of forming a polyamide 66 polymer from a first monomer and a second monomer in which the first monomer comprises a diamine and in which at least a portion of the second monomer is formed from a circular carbon component. The circular carbon component can comprise a circular or renewable natural gas. The second monomer can comprise adipic acid. The renewable natural gas can be steam reformed to produce hydrogen which is combined with a nitrogen gas to form ammonia. The ammonia, which can qualify as blue ammonia, green ammonia, or turquois ammonia, can be combined with water and oxygen to form nitric acid. The nitric acid can be used to oxidize a ketone-alcohol oil to form adipic acid.

In still another embodiment, the present disclosure is directed to producing a polyamide 66 polymer in which at least a portion of the first monomer and at least a portion of the second monomer are formed from the same circular atom component. The circular atom component, for instance, can comprise a circular natural gas, such as a renewable natural gas.

Other features and aspects of the present invention are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a flow diagram of one embodiment of a process in accordance with the present disclosure for producing polyamide 66;

FIG. 2 is a flow diagram of a portion of the process illustrated in FIG. 1;

FIG. 3 is another alternative embodiment of a flow diagram for producing a diamine monomer in accordance with the present disclosure;

FIG. 4 is a flow diagram of a portion of FIG. 1 illustrating the production of an adipic acid monomer;

FIG. 5 is one embodiment of an electrical connector that can be made in accordance with the present disclosure; and

FIG. 6 is another embodiment of an electrical connector that can be made in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present invention.

As used herein, the term “about”, when used to modify an amount or value, refers to an approximation of an amount or value that is more or less than the precisely designated amount or value. The precise value of the approximation is determined by what one of skill in the art would recognize as appropriate. The use of the term “about” conveys the idea that similar values can bring about equivalent results or effects.

In the interests of brevity and conciseness, any ranges of values set forth in this disclosure contemplate all values within the range and are to be construed as support for claims reciting any sub-ranges having endpoints which are whole number values within the specified range in question. By way of hypothetical example, a disclosure of a range of from 1 to 5 shall be considered to support claims to any of the following ranges: 1 to 5; 1 to 4; 1 to 3; 1 to 2; 2 to 5; 2 to 4; 2 to 3; 3 to 5; 3 to 4; and 4 to 5.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40%” is intended to mean “about 40%.”

In general, the present disclosure is directed to producing polyamide polymers, particularly polyamide 66 polymers in a more sustainable manner. In accordance with the present disclosure, a circular carbon component is used directly or indirectly to produce intermediate components and/or monomers for producing the polyamide 66 polymer. More particularly, in accordance with the present disclosure, a single circular carbon component can be used in multiple processes for producing chemical components that are then combined to form a diamine monomer and/or an adipic acid monomer in producing the polyamide polymer.

For instance, the chemical synthesis of the monomers used to produce polyamide 66 is somewhat complicated and involves many steps in producing precursor chemicals. In accordance with the present disclosure, a one or more circular carbon components can be used in producing many of the precursor chemicals that are used to produce the monomers. In one aspect, a single circular atom component, such as a circular carbon component, can also be used to produce both a diamine monomer and an adipic acid monomer. In this manner, the present disclosure is directed to an integrated process that uses circular atoms components in multiple pathways for producing a polyamide polymer with a maximum value of circular atom content.

Polyamide polymers, particularly polyamide 66 polymers, made in accordance with the present disclosure can fulfill the sustainability needs of many manufacturers and customers. The polyamide 66 polymers can be used to produce all different types of products and articles in all different fields. The polyamide 66 polymers, for instance, can be used to produce molded parts and articles for use in the medical field, automotive field, electrical field, the food handling industry, and the like. Manufacturers can incorporate the polyamide 66 polymers into their products in order to meet goals for renewable or bio-based content. Overall, the polyamide 66 polymers made according to the present disclosure can help manufacturers reduce usage of fossil feedstocks and lower their carbon emissions without in any way sacrificing quality or mechanical properties.

In one particular application, for instance, the polyamide 66 polymers can be used in electric vehicles that do not run on fossilized fuels. The polyamide 66 polymers, for instance, can be used to make electrical connectors, battery housings, and other components within the vehicle.

The amount of circular atoms, such as renewable atoms, (carbon and non-carbon) contained in the polyamide 66 polymers of the present disclosure can be determined according to any suitable method. For instance, in one method, the polyamide 66 polymers can be certified according to the International Sustainability and Carbon Certification (ISCC). The ISCC is a globally applicable sustainability certification system and covers various types of sustainable feedstocks, including agricultural and forestry biomass, circular and bio-based materials and renewables, and materials with reduced carbon footprint compared to industrial average. The ISCC can certify the mass balance approach in which the renewable content of the polymer can be verified. In mass balance, renewable feedstock is attributed to selected products, according to their individual chemistry and formulation taking into account all yields and losses. The key criteria used for applying the mass balance approach include feedstock qualification, chain of custody, and product claims.

The mass balance approach makes it possible to track the amount and sustainability characteristics of circular feedstocks, such as renewable feedstocks, in the value chain and attribute it to the final product in a verifiable manner. In one aspect, for instance, the polyamide 66 polymers made according to the present disclosure can have a circular atom content (e.g. renewable, recycled, or the like) of at least about 10% by weight. For instance, the circular atom content of the polyamide 66 polymers can be greater than about 14% by weight, such as greater than about 18% by weight, such as greater than about 22% by weight, such as greater than about 30% by weight, such as greater than about 35% by weight, such as greater than about 40% by weight, such as greater than about 45% by weight, such as greater than about 50% by weight, such as greater than about 55% by weight, such as greater than about 60% by weight, such as greater than about 65% by weight, such as greater than about 70% by weight, such as greater than about 75% by weight. The circular atom content of the polyamide 66 polymers is generally less than about 99% by weight, such as less than about 90% by weight, such as less than about 80% by weight. Due to the complex manner in which polyamide 66 monomers are formed, in the past, it was difficult to obtain a polyamide 66 polymer with any significant circular atom content. Through the processes of the present disclosure, however, much bigger amounts of circular atom content can be incorporated into the polymers in an integrated, efficient and elegant manner.

As described above, the chemical precursors that are used to produce the monomers for producing polyamide 66 are at least partially derived from a circular atom component. The circular atom component can vary depending upon the particular application. The circular atom component, for instance, can comprise a fluid, such as a biogas. A biogas, for instance, is a gas that is produced from biomass. Biogases are produced, for instance, from solid waste landfills and from anaerobic digestion plants, and the like. Alternatively, the circular atom component can comprise a recycled gas. The recycled gas, for instance, may be a gas obtained from an industrial process. Recycled gases, for instance, can be gases that are collected instead of being released to the atmosphere.

The circular atom component can comprise a gas as described above or a liquid, such as a hydrocarbon. In one aspect, the circular atom component comprises a circular natural gas. The natural gas, for instance, can be derived from biomass, such as vegetable by-products, animal by-products, cellulosic by-products, and the like. Alternatively, the natural gas can be a recycled gas from an industrial process or the like that would otherwise be released to the environment. In one embodiment, as will be described in greater detail below, the circular carbon component, such as circular natural gas, can be used in different processes to produce chemical precursors that are then used to produce the monomers for the polyamide 66 polymer.

As described above, in one aspect, the circular carbon component used to produce the polyamide 66 polymers can comprise a circular carbon gas, particularly a circular natural gas. Using a circular natural gas as a starting component to produce many of the chemical precursors in the process of the present disclosure can offer many advantages and benefits. For instance, circular gases, particularly circular natural gas, can contain little to no impurities which prevents impurities from showing up in the final product and interfering with the physical properties of the polymer. For example, in one aspect, the circular carbon component comprises a circular natural gas that contains methane in an amount greater than about 80% by weight, such as in an amount greater than about 85% by weight, such as in an amount greater than about 90% by weight, such as in an amount greater than about 93% by weight, such as in an amount greater than about 95% by weight, such as in an amount greater than about 97% by weight, such as even greater than about 99% by weight.

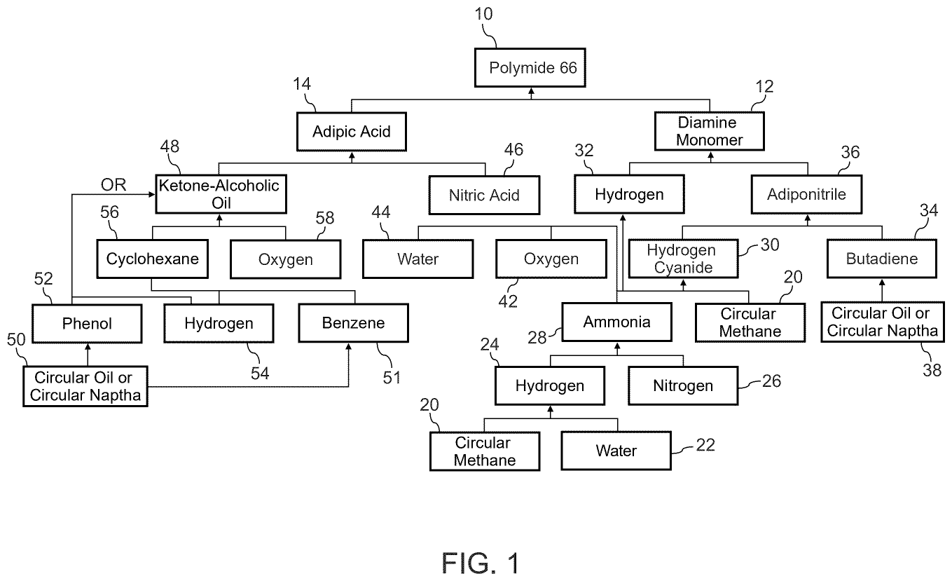

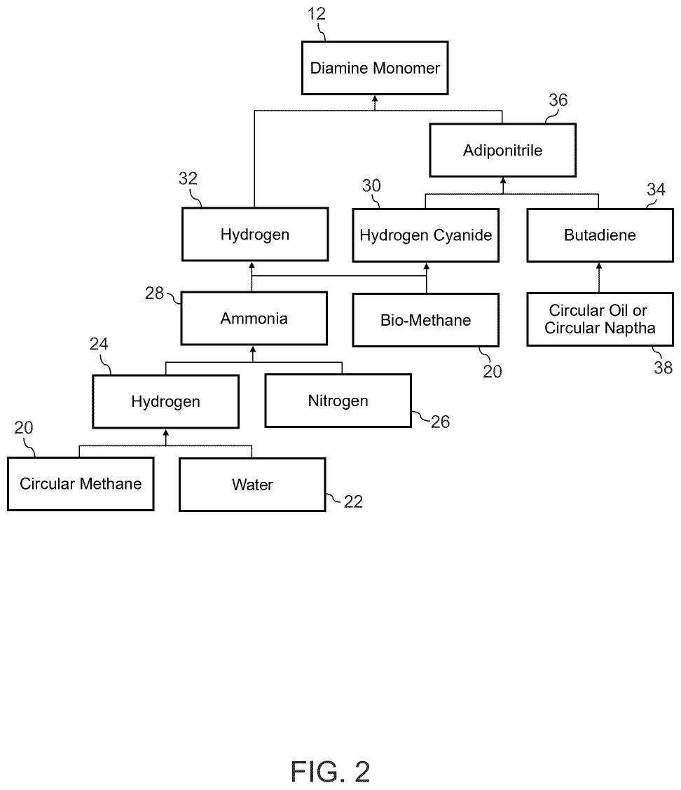

Referring to FIGS. 1 and 2, one embodiment of process for producing a polyamide 66 polymer 10 from a circular atom component is illustrated. As shown, the polyamide 66 polymer 10 is produced from two monomers including a diamine monomer 12 which is combined with adipic acid 14. The diamine monomer 12 can comprise, for instance, hexamethylene diamine, 2-methylpentane-1,5-diamine, or mixtures thereof. In accordance with the present disclosure, the two monomers 12 and 14 are at least partially formed or derived from the circular atom component. In the embodiment illustrated in FIGS. 1 and 2, the circular atom component comprises circular methane 20. As shown, the circular methane 20 is used to produce hydrogen for producing ammonia, which is used to produce hydrogen cyanide, and is used to produce nitric acid. In this way, the circular atom component is inserted into at least three different pathways for forming the two monomers 12 and 14 for maximizing the amount of circular atoms contained in the polyamide polymer 10.

Referring to FIG. 2, the process diagram illustrated in FIG. 1 is isolated for producing the diamine monomer 12, which can comprise hexamethylene diamine. As shown, the process includes combining circular methane 20 in accordance with the present disclosure with water 22 to form hydrogen 24. In this manner, a circular hydrogen 24 is formed.

A common method for converting methane into hydrogen is steam methane reformation. In steam methane reformation, methane and steam are combined in the presence of a catalyst to produce hydrogen gas and carbon monoxide. The carbon monoxide may react with steam to produce more hydrogen, as is detailed in U.S. Pat. No. 3,361,534, which is incorporated by reference. The steam and methane for use in steam methane reformation may be kept at elevated temperatures in the reaction chamber, such as greater than 400 Fahrenheit, such as great than 500 Fahrenheit, such as greater than 600 Fahrenheit, such as greater than 700 Fahrenheit, such as greater than 800 Fahrenheit. Additionally, pressure may be increased about that of atmospheric pressure, such as greater than 5 atmospheres, such as greater than 10 atmospheres, such as greater than 15 atmospheres, such as greater than 20 atmospheres, such as greater than 25 atmospheres, such as greater than 30 atmospheres. Steam methane reformation may take place in the presence of a catalyst, such as a nickel catalyst. It should be understood, however, that the above process and process conditions are merely exemplary and do not in any way limit the process and product of the present disclosure.

As shown, the circular hydrogen 24 is then combined with nitrogen 26 to produce ammonia 28. In one aspect, the ammonia 28 can be produced according to an exothermic process.

A process for producing circular ammonia with hydrogen gas derived from circular methane may be the Haber-Bosch process. The Haber-Bosch process is a reaction which can proceed under high temperatures and pressures. Suitable temperatures may be greater than 750 degrees Fahrenheit, such as greater than 900 degrees Fahrenheit, such as greater than 1000 degrees Fahrenheit, such as greater than 1150 degrees Fahrenheit. Additionally, the process may proceed under pressures greater than 200 atmospheres, such as greater than 300 atmospheres, such as greater than 400 atmospheres. The process also may make use of catalysts, which include catalysts of osmium or iron, but may also include other metals such ruthenium. In addition to the presence of a catalyst, a promoter may be used, such as, but not limited to, molybdenum, potassium oxide or potassium hydroxide. In cases where a catalyst is used, high purity ammonia and circular methane are advantageous when they do not contain sulfur, phosphorus, arsenic or chlorine as impurities. It should be understood that the above process and process conditions are merely exemplary and do not in any way limit the process and product of the present disclosure.

Alternatively, the ammonia 28 can be produced using electrolysis. For instance, in one embodiment, the circular hydrogen 24 and the nitrogen 26 are introduced into an electrochemical cell. Within the cell, nitrogen gas undergoes a reduction reaction, facilitated by the electrical current and possibly a catalyst to produce ammonia.

The produced ammonia can be separated from the electrolyte and other by-products. Separation techniques can include, for instance, distillation or absorption. Any unreacted nitrogen or hydrogen gas can be recycled back to the electrochemical cell to improve efficiency and reduce waste. The exothermic process for producing ammonia may provide advantages over the Haber-Bosch process, such as the ability to operate at milder conditions and potentially lower energy requirements. The Haber-Bosch process, however, may be better suited for large scalability.

The ammonia produced according to the present disclosure can be blue ammonia, green ammonia, and/or turquois ammonia.

As used herein, blue ammonia is ammonia produced using a process that significantly reduces carbon emissions compared to conventional methods. The production of blue ammonia involves producing hydrogen with reduced carbon emissions in comparison to conventional methods, combining it with nitrogen from the air, and synthesizing ammonia via the Haber-Bosch process. The process can incorporate carbon capture to ensure the process remains low-carbon, making blue ammonia an environmentally friendly alternative to traditional ammonia production methods.

In the first step, hydrogen is produced. For instance, Steam Methane Reforming (SMR) may be used. During SMR, circular natural gas (methane) is mixed with steam and heated to produce hydrogen (H2) and carbon monoxide (CO). This H2, CO, and CH4 stream from SMR can further be converted to a stream primarily containing H2, CO2, and N2 via autothermal reforming (ATR) by adding air and reacting over a catalyst. In other instances of blue hydrogen and ammonia production, ATR is the primary reaction used to produce a stream of H2, CO2, and N2. After removal of the CO2, the H2 and N2 stream can be used to synthesize ammonia. In the context of blue ammonia, the CO2 generated during this process is captured and stored or utilized, a method known as Carbon Capture and Storage (CCS) or Carbon Capture, Utilization, and Storage (CCUS). Most blue hydrogen and ammonia processes focus on capturing the CO2 from the from inside the reactors which is increased in concentration prior to being removed from the process. In one instance, blue hydrogen and ammonia can be produced from fossil natural gas. Capturing a portion of the CO2 from the process can reduce the carbon footprint of the products but not change the renewable content of the product. Alternatively, the renewable natural gas can be used to replace fossil natural gas to further reduce the carbon footprint of the products and provide renewable content to downstream products.

Alternatively, hydrogen can be produced using electrolysis, where water is split into hydrogen and oxygen using electricity. In one aspect, the electricity for electrolysis can come from renewable sources or low-carbon sources (such as wind, solar, or hydroelectric power), ensuring the process remains low-carbon. This process is generally referred to as green hydrogen as described below.

Alternatively, renewable hydrogen can be produced from renewable methane pyrolysis to produce hydrogen and carbon black. This renewable hydrogen can be utilized to produce renewable ammonia with lower carbon emissions in comparison to traditional ammonia production methods. This process produces turquois hydrogen and turquois ammonia.

The process also involves obtaining a nitrogen source. Nitrogen (N2) is typically obtained from the air through a process called air separation, where atmospheric air is cooled and distilled to separate nitrogen from other components like oxygen and argon.

The hydrogen and nitrogen are then combined using the Haber-Bosch process to produce the blue ammonia. This involves reacting the gases at high temperature and pressure in the presence of a catalyst to produce ammonia (NH3).

As used herein, green ammonia is produced using renewable energy sources, resulting in minimal carbon emissions throughout the production process. More particularly, green ammonia is produced by electrolyzing water to produce hydrogen using renewable electricity, obtaining nitrogen from the air, and synthesizing ammonia via the Haber-Bosch process, all powered by renewable energy. The reliance on renewable energy throughout the production process ensures that green ammonia has a minimal carbon footprint, making it a sustainable alternative to conventionally produced ammonia.

For instance, hydrogen is first produced through electrolysis from water. Water (H2O) is split into hydrogen (H2) and oxygen (O2) using electricity in an electrolyzer. For green ammonia, the electricity used in this process can come from renewable sources such as wind, solar, hydroelectric power, or by using the circular methane as a fuel source.

Nitrogen is also produced in a sustainable way using air separation. Nitrogen (N2) is separated from atmospheric air. This is typically done through cryogenic distillation, where air is cooled to very low temperatures and then distilled to separate nitrogen from other components like oxygen and argon. The energy required for this process can also come from renewable sources to maintain the green ammonia production criteria.

The Haber-Bosch process is then used to produce the green ammonia. The hydrogen and nitrogen gases are fed into the Haber-Bosch reactor. Under high temperature and pressure, and in the presence of a catalyst, the gases react to form ammonia (NH3). The energy required for this process can again come from renewable sources to ensure the production chain keeps carbon emissions low.

As shown in FIG. 2, the circular ammonia 28 that is produced is then combined with further amounts of the circular methane 20 for producing hydrogen cyanide 30 and possibly more hydrogen 32.

A process for producing hydrogen cyanide may comprise the Andrussow process. In the Andrussow process, ammonia, methane, and oxygen are reacted over a catalyst to form at least HCN. The catalyst may comprise platinum and/or rhodium. Additionally, the Andrussow process is conducted at temperatures higher than room temperature, such as greater than 1800 degrees Fahrenheit, such as greater than 1900 degrees Fahrenheit such as greater than 2000 degrees Fahrenheit, such as greater than 2100 degrees Fahrenheit. The pressure of the reaction may be atmospheric pressure or near atmospheric pressure, such as less than 1 atm, or greater than 1 atm. Pressures greater than atmospheric pressure may be greater than 2 atmospheres, or greater than 3 atmospheres. Additionally, pressures may be less than 3 atmospheres, such as less than 2 atmospheres, such as less than 1 atmosphere, such as less than 0.75 atmospheres. While the reaction chamber may not be particularly limited, one preferred reaction chamber may be a series of tubes. The series of tubes may comprise a bed of catalysts, such as platinum or rhodium. The reaction chamber may be a general reactor. It should be understood, however, that the above process and process conditions are merely exemplary and do not in any way limit the process and product of the present disclosure.

Another way of producing hydrogen cyanide may be the Degussa process, or BMA process. The BMA process also uses methane and ammonia. The BMA process may be conducted at elevated temperatures, such as greater than 1900 degrees Fahrenheit such as greater than 2000 degrees Fahrenheit, such as greater than 2100 degrees Fahrenheit, such as greater than 2200 degrees Fahrenheit. Additionally, the process may take place in the presence of a bed of catalysts, said catalyst comprising platinum. While the reaction chamber for the BMA process may be a general reactor, a particular reactor that may be used is a pipe with platinum catalyst coated inside. In the embodiment wherein the reaction chamber is a pipe, ammonia and methane are passed through the pipe. The ammonia and methane may be at, above, or below atmospheric pressure, such as greater than 1 atmosphere, such as greater than 2 atmospheres, or greater than 3 atmospheres. Additionally, pressures may be less than 3 atmospheres, such as less than 2 atmospheres, such as less than 1 atmosphere, such as less than 0.75 atmospheres. It should be understood, however, that the above process and process conditions are merely exemplary and do not in any way limit the process and product of the present disclosure.

Whether using the Andrussow process or the BMA process, the hydrogen cyanide 30 produced according to the present disclosure contains significant amounts of circular atoms including circular carbon. For instance, in one embodiment, all of the carbon contained in the hydrogen cyanide 30 can comprise circular carbon.

As shown, the hydrogen cyanide 30, in one embodiment, is combined with butadiene 34 for producing adiponitrile 36.

Adiponitrile may be made by the hydrocyanation of 1,3-butadiene. In such a reaction, hydrogen cyanide is reacted with 1,3-butadiene to first form 3-pentenenitrile. As a side product of this reaction, 2-methyl-3-butenenitrile is produced. 2-methyl-2-butenenitrile is isomerized to 3-pentenenitrile. Finally, 3-pentenenitrile undergoes hydrocyanation to form adiponitrile. This process may be carried out at, above, or below atmospheric pressure, such as greater than 1 atmosphere, such as greater than 2 atmospheres, or greater than 3 atmospheres. Additionally, pressures may be less than 3 atmospheres, such as less than 2 atmospheres, such as less than 1 atmosphere, such as less than 0.75 atmospheres. This process may be carried out in the presence of catalysts. Additionally, elevated temperatures may be used, such as greater than 300 degrees Fahrenheit, such as greater than 400 degrees Fahrenheit, such as greater than 500 degrees Fahrenheit, such as greater than 600 degrees Fahrenheit, such as greater than 700 degrees Fahrenheit. It should be understood, however, that the above process and process conditions are merely exemplary and do not in any way limit the process and product of the present disclosure.

In one aspect, the butadiene 34 used to produce the adiponitrile 36 can also have a circular atom content. For instance, the butadiene 34 can be produced from a circular naphtha or a circular pyrolysis oil 38 as shown in FIG. 2.

For instance, in one aspect, the butadiene 34 is produced from circular naphtha. The circular naphtha can be produced from biomass sources like vegetable oils, animal fats, or the like. The circular naphtha is then subjected to steam cracking. In this process, the circular naphtha is heated to high temperatures such as from about 850° C. to about 900° C. in the presence of steam. This causes the larger hydrocarbon molecules to break down into smaller ones. The product of steam cracking contains a mixture of various hydrocarbons, including butadiene 34. Butadiene can be separated from the resulting mixture through a series of purification steps, typically involving distillation and sometimes other methods such as extraction or adsorption.

The separated butadiene can undergo further purification to remove any remaining impurities ensuring high purity of the final product. In this manner, the butadiene 34 can contain a significant portion of circular atom content. In one aspect, for instance, 100% of the carbon contained in the butadiene can comprise circular carbon.

Alternatively as shown in FIG. 2, the butadiene 34 can be produced from a circular oil. The circular oil can be a cooking oil or a pyrolysis oil.

In one aspect, for instance, biomass, such as wood, agricultural residues, or algae is subjected to pyrolysis. Pyrolysis involves heating the biomass in the absence of oxygen to break it down into smaller molecules. This process typically occurs at temperatures ranging from about 400° C. to about 700° C.

The vapors produced during biomass pyrolysis are cooled causing them to condense into a liquid mixture known as pyrolysis oil. This oil contains a wide range of organic compounds, including butadiene precursors.

The pyrolysis oil is then subjected to separation and upgrading processes to isolate the desired compounds, including butadiene. Fractionation techniques, such as distillation or solvent extraction, may be employed to separate the butadiene from the other components in the pyrolysis oil. Depending upon the composition of the pyrolysis oil, additional steps such as hydrogenation or dehydration may be used to convert certain compounds into butadiene. Hydrogenation can saturate double bonds in the molecules, while dehydration can remove water molecules to promote the formation of butadiene.

The butadiene fraction obtained from the above process can undergo further purification to remove any remaining impurities and contaminants.

During production of butadiene using any of the above processes, any other hydrocarbons produced during the process, such as C4 or C5 hydrocarbons can be used as an energy source in producing the butadiene or for use anywhere else in the process.

As shown in FIG. 2, the adiponitrile produced from the hydrogen cyanide 30 and the butadiene 34 can be combined with circular hydrogen to produce the diamine monomer 12.

For instance, adiponitrile may be hydrogenated to form a diamine monomer. The diamine monomer may comprise hexamethylenediamine or 2-methylpentane-1,5-diamine, though one having ordinary skill in the art may recognize that adiponitrile can be used to produce a much larger array of diamines.

The process of hydrogenating adiponitrile into hexamethylenediamine may comprise reacting adiponitrile with hydrogen gas. The hydrogen gas used in hydrogenation of adiponitrile may be a circular hydrogen gas, produced by the above steam reformation process. This process is typically carried out at elevated temperatures, such as greater than 500 degrees Fahrenheit, such as greater than 600 degrees Fahrenheit, such as greater than 700 degrees Fahrenheit, such as greater than 800 degrees Fahrenheit, such as greater than 900 degrees Fahrenheit, such as greater than 1000 degrees Fahrenheit, such as greater than 1100 degrees Fahrenheit. Additionally, pressure may be increased about that of atmospheric pressure, such as greater than 5 atmospheres, such as greater than 10 atmospheres, such as greater than 15 atmospheres, such as greater than 20 atmospheres, such as greater than 25 atmospheres, such as greater than 30 atmospheres. A catalyst may be used in the process of hydrogenation, such as iron, nickel, or rhodium. It should be understood, however, that the above process and process conditions are merely exemplary and do not in any way limit the process and product of the present disclosure.

Alternatively, the Andrussow process described above and the BMA process described above can produce hydrogen gas as a byproduct in formation of hydrogen cyanide. The hydrogen gas can contain renewable content from the use of circular natural gas into the process and circular ammonia into the process. The renewable hydrogen gas byproduct can be captured as shown in FIG. 1. A process for capturing hydrogen, for instance, is described in WO2014099607A1, “Integrated process for hexamethylenediamine production” which is incorporated herein by reference. Capturing and utilizing the renewable hydrogen byproduct from the Andrussow or BMA process with circular natural gas or circular ammonia feedstock can add circular content of up to 7% by weight in hexamethylenediamine and add circular content of up to 3% by weight in Polyamide 66 polymers. (Stoichiometry shows hydrogen generated as byproduct is 50% excess to what is needed to hydrogenate adiponitrile.)

In another embodiment, the diamine may be 2-methylpentane-1,5,diamine, also known as Dytek® A. 2-methylpentane-1,5, diamine can be synthesized by the hydrogenation of 2-methyl-glutaronitrile.

The diamine monomer 12 made in accordance with the present disclosure can contain a significant amount of circular atoms, including carbon and non-carbon atoms. For instance, the diamine monomer 12 can contain circular carbon in an amount greater than about 30% by weight, such as in an amount greater than about 40% by weight, such as in an amount greater than about 45% by weight, such as in an amount greater than about 55% by weight, such as in an amount greater than about 65% by weight, such as in an amount greater than about 75% by weight, such as in an amount greater than about 80% by weight, such as in an amount greater than about 85% by weight, such as in an amount greater than about 90% by weight. The circular atom content of the diamine monomer 12, for instance, can, in various embodiments, be between about 47% by weight and about 93% by weight.

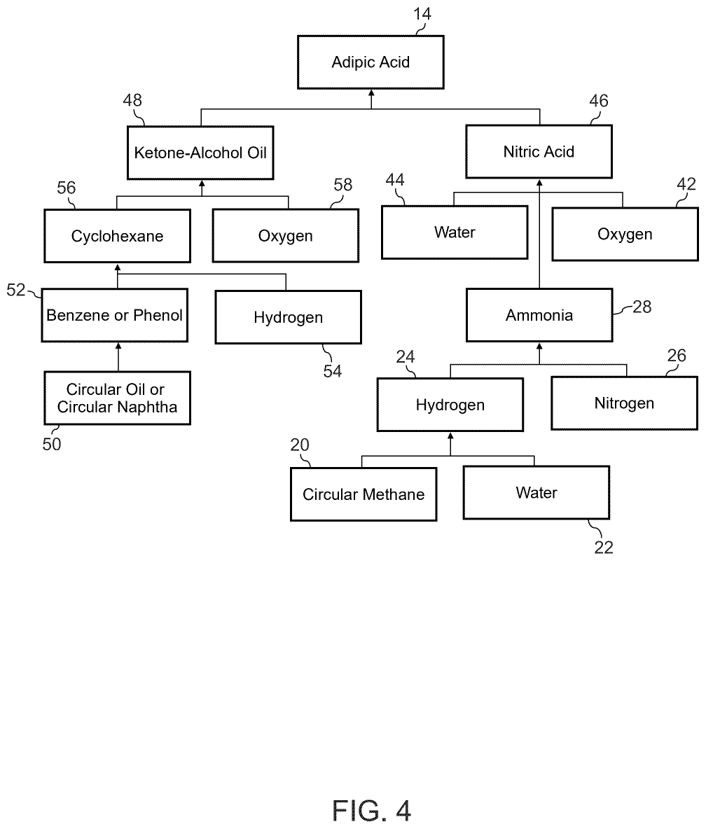

As shown in FIG. 1, in order to produce polyamide 66 polymers, the diamine monomer 12 is reacted with adipic acid 14. Referring to FIG. 4, a portion of FIG. 1 is illustrated showing one pathway for producing adipic acid 14 from the circular carbon component of the present disclosure.

As shown, circular methane 20 is steam reformed using water 22 to produce hydrogen 24 as described above. The hydrogen 24 is combined with nitrogen 26 to produce ammonia 28 as described above, which may be blue ammonia, green ammonia, or turquois ammonia. The circular ammonia 28 is then combined with oxygen 42 and water 44 to produce nitric acid 46. The oxygen 42, water 44, and circular ammonia 28 are combined together at high temperature in the presence of a catalyst to produce the nitric acid 46.

A common reaction scheme follows:

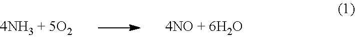

Commonly, this reaction is carried at temperatures greater than 1000 degrees Fahrenheit, such as greater than 1200 degrees Fahrenheit, such as greater than 1400 degrees Fahrenheit, such as greater than 1600 degrees Fahrenheit. Additionally, this reaction is often run in the presence of a rhodium and platinum gauze catalyst. The nitric oxide is then reacted as shown below:

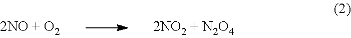

Lastly, nitrogen dioxide is with water according to the reaction below:

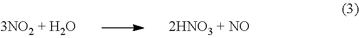

Typically, the first reaction is carried out at low pressures, whereas the second and third reactions are carried out at high pressures. Low pressures for the first reaction can be lower than 10 atmospheres, such as lower than 5 atmospheres, such as lower than 1 atmosphere, such as lower than 0.5 atmospheres. High pressures for the second and third reaction can be higher than 1 atmosphere, such as higher than 5 atmospheres, such as higher than 10 atmospheres, such as higher than 15 atmospheres, such as higher than 20 atmospheres. This nitric acid is often then distilled by extractive distillation using sulfuric acid and a dehydrating agent. It should be understood, however, that the above process and process conditions are merely exemplary and do not in any way limit the process and product of the present disclosure.

As shown in FIG. 4, nitric acid 46 is combined with ketone-alcohol oil 48 in order to form adipic acid 14. Ketone-alcohol oil 48 can be formed from circular oil or circular naphtha 50. The circular oil or naphtha, for instance, can be derived from biomasses described above. As shown in FIG. 2, the circular oil or naphtha can be converted into benzene 51 or phenol 52. The benzene 51 is then combined with hydrogen 54 to form cyclohexane 56. Alternatively, the phenol 52 can be combined with hydrogen 54 to form the ketone-alcohol oil 48. The hydrogen 54, in one aspect, can be derived from the circular methane 20. The cyclohexane 56 is combined with oxygen 58 to form the ketone-alcohol oil 48.

The nitric acid 46 is then combined with the ketone-alcohol oil 48 to produce the second monomer 14 or adipic acid. Adipic acid may be formed by the oxidation of ketone-alcohol oil with nitric acid. Ketone-alcohol oil is a blend containing ketones and alcohols, particularly of cyclonexanol and/or cyclohexanone. In the oxidation of ketone-alcohol oil, nitric acid in the concentration range of 50-60% may be used. The reaction is carried out in the presence of a catalyst, often a copper/ammonium metavanadate catalyst. This process usually results in by-products, including nitrous oxide and hydrogen gas which may optionally be reused or recycled. The reaction is typically run at a temperature of greater than 150 degrees Fahrenheit, such as greater than 250 degrees Fahrenheit, such as greater than 350 degrees Fahrenheit, such as greater than 450 degrees Fahrenheit. Additionally, the synthesis of adipic acid from ketone-alcohol oil and nitric acid is often conducted at pressures greater than atmospheric pressure, such as greater than 5 atmospheres, such as greater than 10 atmospheres, such as greater than 15 atmospheres or such as greater than 20 atmospheres.

Adipic acid 14 made in accordance with the present disclosure as shown in FIG. 4 can have a circular atom content of greater than about 20%, such as greater than about 25%, such as greater than about 30%, such as greater than about 35%, such as greater than about 40%. The circular atom content of the adipic acid is generally less than about 99%, such as less than about 80%.

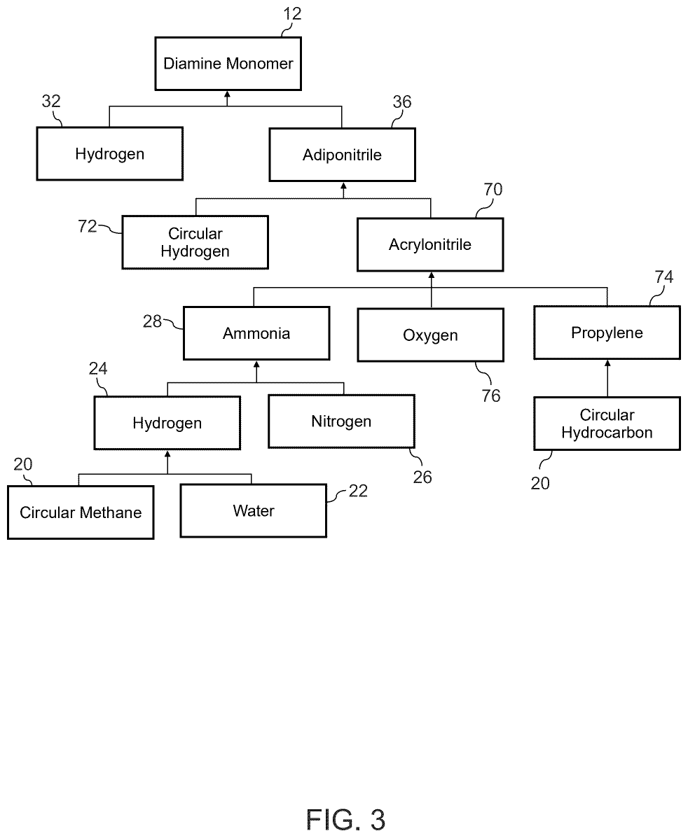

Referring to FIG. 3, an alternative embodiment for producing the diamine monomer 12 is shown. Like reference numerals have been used to indicate similar elements. In the embodiment in FIG. 3, similar to the embodiment in FIG. 2, circular methane 20 is steam reformed with water 22 to form hydrogen 24. The hydrogen 24 is combined with nitrogen 26 to produce ammonia 28.

In the embodiment illustrated in FIG. 3, however, acrylonitrile 70 is produced containing circular carbon that is then combined with hydrogen 72 for producing the adiponitrile 36.

In order to form the acrylonitrile 70, the circular methane 20 is first used to produce propylene 74. To produce propylene (propene, C₃H₆) from methane (CH₄), a series of chemical processes can be employed. For instance, in one embodiment, the first step is to convert methane into a synthesis gas (syngas), a mixture of hydrogen (H₂) and carbon monoxide (CO). This can be done through steam methane reforming (SMR):

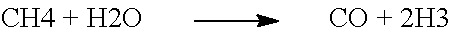

The syngas can then be converted into methanol (CH₃OH) via a catalytic process:

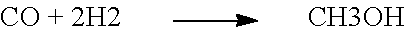

The methanol can be converted into light olefins such as ethylene (C₂H₄) and propylene through a Methanol-to-Olefins (MTO) process. MTO processes are disclosed in U.S. Pat. Nos. 10,011,541 and 11,001,542, which are incorporated herein by reference. Any other hydrocarbons produced during the process, such as C4 or C5 hydrocarbons can be used as an energy source for increasing the efficiency in producing propylene. The process can include dehydration and cracking reactions:

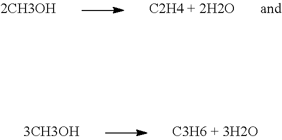

Alternatively, there is a specific Methanol-to-Propylene (MTP) process developed to maximize the yield of propylene.

In another embodiment, Oxidative Coupling of Methane (OCM) can be used to directly convert methane into ethylene, which can then be oligomerized and cracked to produce propylene. The process involves the oxidative coupling of methane molecules, typically using oxygen (O₂) as the oxidizing agent. The process requires catalysts to facilitate the reaction. Common catalysts include metal oxides such as those of lithium, magnesium, and lanthanum. These catalysts help lower the activation energy required for the reaction and improve selectivity toward the desired products. The basic mechanism involves the activation of methane and oxygen on the catalyst surface, forming methyl radicals (CH₃·) and other reactive intermediates. These intermediates then couple to form C₂ hydrocarbons. The initial step can be represented as follows:

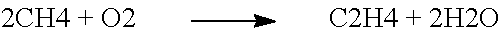

The ethylene can then be converted into propylene via processes like the olefin metathesis reaction:

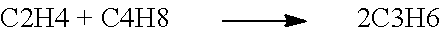

In still another embodiment, methane pyrolysis can be used to form propylene. Methane can be directly decomposed into hydrogen and acetylene at high temperatures. The acetylene can then be converted to ethylene and further to propylene.

Still another route involves converting syngas directly to hydrocarbons via the Fischer-Tropsch process, producing a range of hydrocarbons that can be further refined and cracked to obtain propylene.

The propylene 74 containing circular carbon is then combined with oxygen 76 and the ammonia 28 formed from the circular methane 20.

For example, in one aspect, the acrylonitrile 70 can be produced from the ammonia 28, oxygen 76, and propylene 74 in a process known as the SOHIO process. During this process, the ammonia, propylene, and oxygen are combined in a single reactor to convert to acrylonitrile 70 and hydrogen cyanide. This reaction can take place in the presence of a catalyst in a fluidized bed. The acrylonitrile 70 contains circular carbon and/or other circular atoms.

As shown in FIG. 3, the acrylonitrile 70 is then combined with hydrogen 72 to form the adiponitrile 36. The hydrogen 72, for instance, can be obtained from the circular methane 20 through a steam reforming process.

The production of adiponitrile from acrylonitrile and hydrogen involves a catalytic hydrogenation reaction. The reaction occurs in the presence of a catalyst, such as a nickel-based catalyst. The acrylonitrile 70 is converted to the adiponitrile 36 during the process. The adiponitrile 36 can then be combined with further amounts of hydrogen 32 for producing the diamine monomer 12.

In the reaction scheme illustrated in FIG. 3, the diamine monomer 12 can contain circular oxygen in an amount greater than about 20% by weight, such as in an amount greater than about 25% by weight, such as in an amount greater than about 30% by weight, such as in an amount greater than about 35% by weight, such as in an amount greater than about 40% by weight, such as in an amount greater than about 45% by weight, such as in an amount greater than about 50% by weight, and in an amount less than about 90% by weight, such as in an amount less than about 85% by weight, such as in an amount less than about 80% by weight. For instance, in one aspect, the diamine monomer 12 can contain circular atoms in an amount from about 29% by weight to about 72% by weight depending upon recurrent use of the circular methane 20.

The diamine monomer 12 and the adipic acid 14 made in accordance with the present disclosure are then combined together to form a polyamide polymer, particularly a polyamide 66 polymer 10 as shown in FIG. 1. For instance, the polyamide 66 polymer 10 can be produced through a polycondensation reaction between the adipic acid and the diamine.

Polyamide 66 polymers made according to the present disclosure can have excellent physical and mechanical properties and can contain little to no impurities.

Polyamide 66 polymers made in accordance with the present disclosure, for instance, can have a relative viscosity of greater than about 2.3, such as greater than about 2.4, such as greater than about 2.5, and less than about 3.2, such as less than about 3, such as less than about 2.9, such as less than about 2.8, such as less than about 2.7, when tested according to ASTM Test D789 and/or D4878.

Once produced, the polyamide 66 polymers can be combined with various additives and ingredients for producing compounded polymer compositions. The compounded polymer compositions are then well suited for producing various articles through molding processes, such as injection molding.

For instance, in one embodiment, the polyamide 66 polymer can be combined with reinforcing fibers, such as inorganic fibers.

The inorganic fibers generally have a high degree of tensile strength relative to their mass. For example, the ultimate tensile strength of the fibers (determined in accordance with ASTM D2101) is typically from about 1,000 to about 15,000 MPa, in some embodiments from about 2,000 MPa to about 10,000 MPa, and in some embodiments, from about 3,000 MPa to about 6,000 MPa. The high strength fibers may be formed from materials that are also electrically insulative in nature, such as glass, ceramics (e.g., alumina or silica), etc., as well as mixtures thereof. Glass fibers are particularly suitable, such as E-glass, A-glass, C-glass, D-glass, AR-glass, R-glass, S1-glass, S2-glass, etc., and mixtures thereof. The inorganic fibers may have a relatively small median diameter, such as about 50 micrometers or less, in some embodiments from about 0.1 to about 40 micrometers, and in some embodiments, from about 2 to about 20 micrometers, such as determined using laser diffraction techniques in accordance with ISO 13320:2009 (e.g., with a Horiba LA-960 particle size distribution analyzer). It is believed that the small diameter of such fibers can allow their length to be more readily reduced during melt blending, which can further improve surface appearance and mechanical properties. After formation of the polymer composition, for example, the average length of the inorganic fibers may be relatively small, such as from about 10 to about 800 micrometers, in some embodiments from about 100 to about 700 micrometers, and in some embodiments, from about 200 to about 600 micrometers. The inorganic fibers may also have a relatively high aspect ratio (average length divided by nominal diameter), such as from about 1 to about 100, in some embodiments from about 10 to about 60, and in some embodiments, from about 30 to about 50.

In one aspect, glass fibers can be present in the polymer composition in an amount from about 5% by weight to about 65% by weight. For instance, glass fibers can be present in an amount greater than about 15% by weight, such as in an amount greater than about 20% by weight, such as in an amount greater than about 25% by weight, and in an amount less than about 63% by weight, such as in an amount less than about 50% by weight.

A wide variety of additional additives can also be included in the polyamide composition, such as impact modifiers, compatibilizers, particulate fillers (e.g., mineral fillers), lubricants, pigments, antioxidants, light stabilizers, heat stabilizers, and/or other materials added to enhance properties and processability. In certain embodiments, for example, the composition may contain a UV stabilizer. Suitable UV stabilizers may include, for instance, benzophenones, benzotriazoles (e.g., 2-(2-hydroxy-3,5-di-α-cumylphenyl)-2H-benzotriazole (TINUVIN® 234), 2-(2-hydroxy-5-tert-octylphenyl)-2H-benzotriazole (TINUVIN® 329), 2-(2-hydroxy-3-α-cumyl-5-tert-octylphenyl)-2H-benzotriazole (TINUVIN® 928), etc.), triazines (e.g., 2,4-diphenyl-6-(2-hydroxy-4-hexyloxyphenyl)-s-triazine (TINUVIN® 1577)), sterically hindered amines (e.g., bis(2,2,6,6-tetramethyl-4-piperidyl)sebacate (TINUVIN® 770) or a polymer of dimethyl succinate and 1-(2-hydroxyethyl)-4-hydroxy-2,2,6,6-tetramethyl-4-piperidine (TINUVIN®622)), and so forth, as well as mixtures thereof. When employed, such UV stabilizers typically constitute from about 0.05 wt. % to about 2 wt. % in some embodiments from about 0.1 wt. % to about 1.5 wt. %, and in some embodiments, from about 0.2 wt. % to about 1.0 wt. % of the composition.

In one embodiment, the polymer composition contains a heat stabilizer. The heat stabilizer, for instance, can comprise dipentaerythritol. The heat stabilizer can be present in the polymer composition in an amount greater than about 0.3% by weight, such as in an amount greater than about 0.5% by weight, such as in an amount greater than about 0.7% by weight, such as in an amount greater than about 1% by weight, such as in an amount greater than about 1.2% by weight, such as in an amount greater than about 1.4% by weight, and in an amount less than about 5% by weight, such as in an amount less than about 3% by weight, such as in an amount less than about 2% by weight, such as in an amount less than about 1.8% by weight.

In general, other additives and fillers, processing stabilizers, lubricants, and the like can be present in the polymer composition in an amount from about 0.01% by weight to about 60% by weight.

Shaped parts may be formed from the polyamide composition using a variety of different techniques. Suitable techniques may include, for instance, injection molding, low-pressure injection molding, extrusion compression molding, gas injection molding, foam injection molding, low-pressure gas injection molding, low-pressure foam injection molding, gas extrusion compression molding, foam extrusion compression molding, extrusion molding, foam extrusion molding, compression molding, foam compression molding, gas compression molding, etc. For example, an injection molding system may be employed that includes a mold within which the polyamide composition may be injected. The time inside the injector may be controlled and optimized so that polymer matrix is not pre-solidified. When the cycle time is reached and the barrel is full for discharge, a piston may be used to inject the composition to the mold cavity. Compression molding systems may also be employed. As with injection molding, the shaping of the polyamide composition into the desired article also occurs within a mold. The composition may be placed into the compression mold using any known technique, such as by being picked up by an automated robot arm. The temperature of the mold may be maintained at or above the solidification temperature of the polymer matrix for a desired time period to allow for solidification. The molded product may then be solidified by bringing it to a temperature below that of the melting temperature. The resulting product may be de-molded. The cycle time for each molding process may be adjusted to suit the polymer matrix, to achieve sufficient bonding, and to enhance overall process productivity.

The nylon 66 of the present disclosure can be used to produce all different types of products and components. For instance, the nylon 66 can be used to make all different types of automotive parts including engine components such as gears, bearings, and other mechanical parts and interior components such as seatbelts, airbag containers, and upholstery. The nylon 66 can also be used to in industrial applications to produce machinery parts such as gears, bearings, and bushings, electrical components such as cable ties, electrical insulators, and connectors, and filtration systems such as filters and screens in industrial applications. The nylon 66 can be used in medical applications to produce surgical sutures and medical devices. The nylon 66 can also be used to produce packaging such as food packaging films and bags. Nylon 66 is used to produce textiles and apparel. Nylon 66 is also used to produce all different types of consumer goods such as sporting equipment, kitchen utensils, brushes, zippers, and toys.

Particular products and components that can be made from the nylon 66 of the present disclosure include anti-vibration and suspension systems, traction motors, clips, clamps, body plugs, grommets, cable ties, end caps, propulsion cooling systems, air management systems, cockpit components, high speed data and low voltage connectors, wire and cables, oil management systems, exterior trims and parts, engine parts, closures and fasteners, power electronics, rail and train systems, steering systems, charging plug and socket components, injection device components, traction motor components, circuit breakers and contactors, storage tanks and vessels, solar photovoltaic components, furniture components, brake system components, transmission components, wheeled sport components, switches, pedals and gear shift systems, door components, fluid management parts, tubes, hoses, and pipes, oil management components, sockets, plumbing hardware, relays, fuses and switches, filaments, fibers and fabrics, fuel cell components, military, weapons and munition components, sensors, tools, motorcycle parts, safety restraint systems, coil form and transformer parts, front and rear end module components, conveyor chains and belts, relays, fuel supply system components, seats and seating system components, ADAS (Advanced Driver Assistance Systems) components, agriculture and mining parts, footwear, medical packaging, server parts, air conditioning parts, ropes, cordage, nettings, lithium-ion battery components, water management (irrigation and drainage) components, windshield wiper and washer system components, 5G base station components, tabletop computer components, automation and robotic (Drones, AMR, AGV) systems parts and components, and the like.

Nylon 66 is particularly well suited for use in electric vehicles to make battery components and housings, electrical connectors, terminal blocks, and other electrical components.

For example, the present inventors have discovered that the polyamide composition is particularly suitable for use in electrical connectors, such as those employed in electric vehicles and household appliances. The connector may contain insertion passageways that are configured to receive contact pins. These passageways are defined by opposing walls, which may be formed from the polyamide composition of the present invention. The walls may have a width of from about 500 micrometers or less, in some embodiments from about 100 to about 450 micrometers, and in some embodiments, from about 200 to about 400 micrometers.

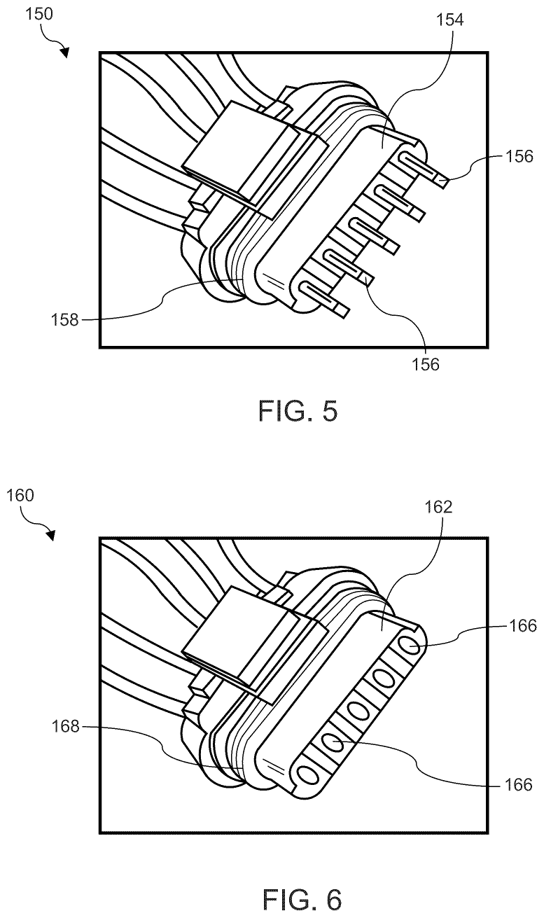

Referring to FIGS. 5 and 6, embodiments of electrical connectors that can be made in accordance with the present disclosure are shown.

Referring to FIG. 5, one embodiment of a high-voltage connector 150 that may be made in accordance with the present disclosure is shown. The electrical connector 150 includes a plurality of contact elements 156 extending from a base 154. The contact elements 156 are for making an electrical connection to an opposing connector. In the embodiment illustrated in FIG. 5, the contact elements 156 are male contacts that are to be inserted into opposing receptors.

As shown in FIG. 5, the connector 150 further includes a gasket 158. The gasket 158 is for providing a fluid-tight connection when the connector is engaged with a complementary receptacle. The gasket can be made from any suitable elastomer or rubber. In one aspect, for instance, the gasket 158 is made from a silicone elastomer.

Referring to FIG. 6, another connector 160 made in accordance with the present disclosure is shown. The connector 160 is for receiving and attaching to the connector 150 as shown in FIG. 5. The connector 160 includes a base 162 that surrounds and forms walls around a plurality of contact elements 166. The contact elements 166 are female connectors for receiving the male contact elements 156 from connector 150 as shown in FIG. 5. As shown, the connector 160 also includes a gasket 168 similar to the embodiment illustrated in FIG. 5.

In accordance with the present disclosure, the base 154 of the connector 150 and the base 162 of the connector 160 can be made from the polymer composition of the present disclosure.

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims

1. A method for producing polyamide 66 comprising:
forming a polyamide 66 polymer from a first monomer and a second monomer, wherein at least a portion of the first monomer is derived from a circular atom component, the first monomer comprising a diamine, the second monomer comprising adipic acid, the circular atom component comprising a circular carbon component comprising circular natural gas, and wherein the resulting polyamide 66 polymer has a circular atom content of at least about 10% by weight.

2. A method as defined in claim 1, wherein the resulting polyamide 66 polymer has a circular atom content of at least about 14% by weight.

3. (canceled)

4. A method as defined in claim 1, wherein the circular atom content is determined according to ISCC.

5. A method as defined in claim 1, wherein the circular natural gas comprises a circular methane containing methane in an amount greater than about 80% by weight.

6. A method as defined in claim 1, wherein the first monomer comprises hexamethylene diamine.

7. A method as defined in claim 1, wherein the first monomer comprises 2-methylpentane-1,5-diamine.

8. A method as defined in claim 1, wherein the circular natural gas is steam reformed to produce hydrogen which is combined with nitrogen gas to form ammonia, the ammonia being combined with additional amounts of the circular natural gas to form hydrogen cyanide, the hydrogen cyanide being used to form adiponitrile, the adiponitrile being hydrogenated to form the first monomer.

9. A method as defined in claim 8, wherein the adiponitrile is hydrogenated with hydrogen captured during the production of hydrogen cyanide.

10. A method as defined in claim 8, wherein the ammonia comprises blue ammonia, green ammonia, or turquois ammonia.

11-12. (canceled)

13. A method as defined in claim 8, wherein the adiponitrile is formed by hydrocyanation of 1,3 butadiene.

14. A method as defined in claim 13, wherein the 1,3 butadiene is formed from a circular carbon component comprising a circular oil or circular naphtha.

15. (canceled)

16. A method as defined in claim 1, wherein the circular natural gas is steam reformed to produce hydrogen which is combined with nitrogen gas to form ammonia, the ammonia being combined with oxygen and propylene to form acrylonitrile, the acrylonitrile being converted to adiponitrile, which is hydrogenated to form the first monomer.

17. A method as defined in claim 16, wherein the propylene is derived from a circular carbon component comprising the circular natural gas.

18. A method as defined in claim 1, wherein the polyamide 66 polymer has a relative viscosity of from about 2.3 to about 3.2 when tested according to ASTM Test D789 and/or D4878.

19. A method as defined in claim 1, wherein the polyamide 66 polymer has a relative viscosity of from about 2.4 to about 2.7 when tested according to ASTM Test D789 and/or D4878.

20. A method as defined in claim 1, wherein the polyamide 66 polymer is combined with glass fibers, the glass fibers being present in the resulting polymer composition in an amount of from about 5% by weight to about 65% by weight.

21. (canceled)

22. A method as defined in claim 1, wherein the polyamide 66 polymer is molded into an article.

23. A method as defined in claim 22, wherein the molded article comprises an electrical connector.

24. A method for producing polyamide 66 comprising:
forming a polyamide 66 polymer from a first monomer and a second monomer, wherein the first monomer comprises a diamine and wherein at least a portion of the second monomer is derived from a circular carbon component, the circular carbon component comprising a circular natural gas, the second monomer comprising adipic acid and wherein the circular natural gas is steam reformed to produce hydrogen which is combined with a nitrogen gas to form ammonia, the ammonia being combined with water and oxygen to form nitric acid, the nitric acid being used to oxidize a ketone-alcohol oil to form adipic acid.

25-28. (canceled)

29. A method for producing polyamide 66 comprising:
forming a polyamide 66 polymer from a first monomer and a second monomer, wherein at least a portion of the first monomer and at least a portion of the second monomer are derived from the same circular carbon component, the circular carbon component comprising a circular natural gas, and wherein the resulting polyamide 66 polymer has a circular atom content of at least about 10% by weight.

30-47. (canceled)
